(19) United States
(12) Patent Application Publication
(10) Pub. No.: US 2020/0334047 A1
(43) Pub. Date: Oct. 22, 2020

(54) SYSTEMS AND COMPUTER-IMPLEMENTED METHODS FOR MANAGING APPLICATION CONFIGURATIONS

(71) Applicant: Mastercard International Incorporated, Purchase, NY (US)

(72) Inventor: Jen Sparks, St. Louis, MO (US)

(73) Assignee: Mastercard International Incorporated, Purchase, NY (US)

(21) Appl. No.: 16/388,381

(22) Filed: Apr. 18, 2019

(51) Int. Cl. G06F 9/445; G06F 9/54; G06F 11/30

(52) U.S. Cl. CPC G06F 9/44505; G06F 11/3079; G06F 9/542

(57) ABSTRACT

A computer-implemented method for managing configuration sets for computer applications. The method includes connecting with a utility application via an application programming interface (API) associated with the utility application. The method additionally includes obtaining, via the API, a configuration set for the utility application. The configuration set includes one or more configurations associated with end-user functions of the utility application. The method additionally includes communicatively connecting with a datasource storing a plurality of managed configurations. The method additionally includes comparing the configuration set obtained for the utility application with the managed configurations stored in the datasource. The method further includes identifying differences between the configuration set obtained for the utility application with the managed configurations stored in the datasource. Based on the identified differences, configurations may be provisioned to or removed from the utility application. In addition, updated configurations may be downloaded from the utility application to the configuration datastore.

### FIELD OF THE INVENTION

The present disclosure generally relates to systems and computer-implemented methods for managing application configurations. More particularly, embodiments of the present invention include systems and computer-implemented methods for auditing and updating configurations and/or configuration sets for computer applications.

### BACKGROUND

Existing business software applications generally include end-user function configurations that can only be established and updated directly through the applications. For example, some software applications will be configured to generate, for display, a front-end graphical user interface (GUI) through which changes can be made to configurations for end-user functions of the software applications. Unfortunately, such front-end GUIs require manual interactions by users and do not allow for the automation of managing configurations. The necessity of manual interactions can lead to inaccuracies, missed steps, and lack of backups when managing configurations for the software applications. Such problems are enhanced when multiple instances of the software applications are required to have identical configurations. Such problems are further enhanced as the configurations increase in scope and complexity.

This background discussion is intended to provide information related to the present invention which is not necessarily prior art.

### BRIEF SUMMARY

Embodiments of the present technology relate to systems and computer-implemented methods for managing configurations for computer applications. The embodiments may enable management of computer applications, including automatic querying, provisioning, removal, and copying/downloading of configurations applicable to the computer applications. As such, embodiments provide a consistent and repeatable approach for managing configurations of computer applications.

More particularly, in a first aspect, a computer-implemented method for managing configuration sets for computer applications, via one or more transceivers and/or processors, may be provided. The method may include communicatively connecting with a utility application via an application programming interface (API) associated with the utility application. The method may additionally include obtaining, via the API, a configuration set for the utility application. The configuration set includes one or more configurations associated with end-user functions of the utility application. The method may additionally include communicatively connecting with a datasource storing a plurality of managed configurations. The method may additionally include comparing the configuration set obtained for the utility application with the managed configurations stored in the datasource. The method may further include identifying differences between the configuration set obtained for the utility application and the managed configurations stored in the datasource.

In another aspect, a system for managing configuration sets for computer applications may be provided. The system may include one or more processors individually or collectively programmed to perform the steps described in this paragraph. One step may include communicatively connecting with a utility application via an application programming interface (API) associated with the utility application. An additional step may include, obtaining, via the API, a configuration set for the utility application. The configuration set includes one or more configurations associated with end-user functions of the utility application. An additional step may include communicatively connecting with a datasource storing a plurality of managed configurations. An additional step may include comparing the configuration set obtained for the utility application with the managed configurations stored in the datasource. A further step may include identifying differences between the configuration set obtained for the utility application with the managed configurations stored in the datasource.

In still another aspect, a system comprising computer-readable media having computer-executable instructions stored thereon for managing configuration sets for computer applications may be provided. The computer-readable instructions may instruct at least one processor to perform the steps described in this paragraph. One step may include communicatively connecting with a utility application via an application programming interface (API) associated with the utility application. An additional step may include, obtaining, via the API, a configuration set for the utility application. The configuration set includes one or more configurations associated with end-user functions of the utility application. An additional step may include communicatively connecting with a datasource storing a plurality of managed configurations. An additional step may include, comparing the configuration set obtained for the utility application with the managed configurations stored in the datasource. A further step may include identifying differences between the configuration set obtained for the utility application with the managed configurations stored in the datasource.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for managing configurations of computer applications in accordance with embodiments of the present invention;

FIG. 2 illustrates various components of an exemplary computing device shown in block schematic form that may be used with the system of FIG. 1;

FIG. 3 illustrates various components of an exemplary server device shown in block schematic form that may be used with the system of FIG. 1;

FIG. 4 illustrates various components of another exemplary server device shown in block schematic form that may be used with the system of FIG. 1;

FIG. 5 is a flowchart illustrating at least a portion of the steps of a method for managing configurations of computer applications in accordance with embodiments of the present invention;

FIG. 6 is a flowchart illustrating at least a portion of the steps of another method for managing configurations of computer applications in accordance with embodiments of the present invention; and

FIG. 7 is a flowchart illustrating at least a portion of the steps of yet another method for managing configurations of computer applications in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Embodiments of the present invention are directed to systems and computer-implemented methods for managing configurations for computer applications. For example, such computer applications may comprise business utility (BU) applications used by businesses to perform business functions. Exemplary BU applications may include computer programs used for: business services, application monitoring/managing, data analytics, and the like. Generally, such BU applications can be accessed by end-users to perform and/or access one or more end-user application functions of the BU applications. In general, such end-user application functions are tasks, procedures, and/or features of the BU application that permit the end-user to interact with the BU application, to control operation the BU application, to obtain information from the BU application, etc. Examples of such end-user application functions may include user/event alerts, dashboard arrangements, user preferences, scheduled reports, tags, calculatable fields/values, lookup functions (e.g., csv lookup, key-value stores, etc.), and/or other end-user application functionalities or features owned or associated with a particular user.

In more detail, user/event alerts may be application functions that provide for the BU application to generate an alert (e.g., a graphical alert via a GUI of the BU application, an email, an SMS message, and/or another action in an external system) upon a particular criterion being met. A dashboard arrangement may be the specific GUI layout that the end-user uses to interact with the BU application and/or to obtain real-time information, data, and metrics from the BU application. Scheduled reports may be used by the end-user to obtain historical or regularly-scheduled information from the BU application. Tags, calculatable field/values, and lookup functions may be application rules or processes that are implemented for use during operation of the BU application.

Commonly, application functions for BU applications will be regulated by configurations. Such configurations may be in the form of data, source code, or other higher-level instructions associated with the BU applications. Often, the configurations for BU applications will be stored in memory elements of the computing devices in which the BU applications are stored and executed. For example, the application function configurations for a BU application may form part of the source code or executable code of the BU application.

A given end-user may have a plurality of individual configurations for the end-user's use of a particular BU application. Such configurations may each be applicable to one of the application functions (e.g., user alerts, dashboard arrangement, scheduled reports) that are specifically configured for use by the end-user. The collection of configurations for a given end-user of a BU application may be referred to herein as a “configuration set.” In some cases, there may be multiple executable instances of a BU application, with each instance being associated with a separate end-user's use of the BU application. Alternatively, or in addition, an individual instance of a BU application may be associated with production and non-production occurrences of the BU application. Nevertheless, because each end-user may have his/her own configuration set (which is applicable to his/her own configurations of end-user application functions for the BU application), the BU application may be associated with multiple configuration sets. In some embodiments, it may be beneficial for each of the configuration sets for the end-users to be synchronized for uniformity. In further embodiments, it may be beneficial for portions of the configurations to be unique, with other portions being synchronized.

Embodiments of the present invention are configured to efficiently and accurately manage the configurations for end-user application functions of BU applications. In particular, embodiments may include a management application configured to query the configurations for end-user application functions of a BU application to determine if the currently-implemented configurations are the correct configurations for use with the BU application. The management application may be a computer program, also referred to as instructions, code, code segments, software, firmware, programs, applications, apps, services, daemons, or the like, which is configured to perform one or more of the operations described herein. In addition to performing queries, the management application may be configured to provision configurations, e.g., provide new or updated configurations, to the BU application. Furthermore, the management application may be configured to remove configurations, e.g., invalid, expired, unsuitable, untracked, or otherwise unmanaged configurations, from the BU application. The term “unmanaged configurations” is defined in more detail below. In some embodiments, removal of the configurations may include the deletion and/or extraction of unmanaged configurations from the BU application. In some alternative, or additional embodiments, as will be discussed in more detail below, certain unmanaged configurations may remain in association with the BU application, while such unmanaged configurations are downloaded or copied for further reference and analysis, as will be described in more detail below. In some embodiments, configurations may be provisioned or removed from the BU application based on the query performed by the management application. In other embodiments, configurations may be provisioned or removed in an automated fashion (e.g., automatically provisioning a new version of a configuration to the BU application upon the new version of the configuration being generated).

To help facilitate the management of configurations for end-user application functions of BU applications, embodiments may include a configuration datasource that stores managed configurations for the BU application. Such managed configurations may comprise the most current and up-to-date configurations that are to be used by the BU application. Embodiments provide for the managed configurations to include each configuration for each configuration set associated with the BU application. Stated differently, the managed configurations will include each configuration of an end-user application function used by each end-user of the BU application (i.e., for each instance of the BU application). In some additional embodiments, the configuration datasource may be include or be associated with a version control system that stores historical information for each of the managed configurations. For example, the configuration datasource may store metadata for each of the managed configurations, with such metadata including a version number (e.g., version 1.0, 1.1, etc.), a creation timestamp (e.g., month, day, time), an author/creator identifier (e.g., author name), a textual comment (e.g., textual comment indicative of the purpose of the configuration or change thereto), and/or the like. As such, the managed configurations can be analyzed to determine when particular changes were made, why the changes were made, and who authored such changes.

As used herein, the term “unmanaged configurations” refers to configurations included and/or associated with the BU application, but which are not part of the most current, up-to-date managed configurations stored in the configuration datasource. As noted above, in certain embodiments, some unmanaged configurations may be downloaded or copied on to the configuration datasource for further reference and analysis. For example, if the BU application includes a new or updated configuration set, such new or updated configuration set may be downloaded or copied on to the configuration datasource and references as the most current and up-to-date configurations for the BU application.

In view of the above, embodiments of the present invention provide for the management of configurations for end-user application functions of BU applications. For example, the management application may query the currently-implemented configurations used by a particular BU application. To begin, the management application may communicate with the BU application to determine which configurations or configuration sets are currently in use by the BU application. To assist with such communication, embodiments may provide for the BU application to include and/or otherwise be associated with an application programming interface (API) that facilitates communication and data transfer between resources and the BU application. In some embodiments, the API will be a create, read, update, and delete (CRUD) API or a CRUD-like API. In some specific embodiments, for example, the API will be a RESTful API. In certain embodiments, the management application may simply communicate with the BU application, via the API, to discover which configurations are currently being implemented by the BU application. In some specific embodiments, however, the management application may copy or download, via the API, the configurations currently being implemented by the BU application for storage, at least temporarily, on the computing device associated with the management application.

Nevertheless, upon determining the currently-implemented configurations being used by the BU application, the management application may communicate with the configuration datastore to determine and access the most-current and up-to-date managed configurations applicable for the BU application. In some embodiments, the management application may copy or download the managed configuration from the configuration datasource. Regardless, the management application can compare the currently-implemented configurations of the BU application (i.e., for end-user application functions) with the managed configurations from the configuration datasource to determine whether any differences exist. For example, such differences could include the configurations of the BU application including one or more extra, additional, unwanted, untracked, or otherwise unmanaged configurations than are included in the managed configurations. Alternatively, such differences may include the configurations of the BU application including one or more missing configurations (e.g., lacking the most up-to-date configurations) than are included in the managed configurations. The management application may generate a report that lists such differences for presentation to a user of the management application. Such a report may be referred to herein as a “difference report.” As was noted previously, in some embodiments, the BU application may be associated with a plurality of configuration sets (each being associated with an instance of the BU application). As such, embodiments may provide for the management application to determine a difference between the managed configurations and each configuration of each configuration set of the Bu application, and to generate a difference report indicative of such determined differences.

In addition to performing the query operations, the management application may be configured to provision and remove configurations to/from the BU application. For example, if based on the query, it is determined that the BU application lacks one or more configurations and/or lacks the most up-to-date configurations, the managed application may facilitate the provisioning of such configuration to the BU application. In particular, the managed application may push one or more configurations that are missing from the BU application from the configuration datasource to the BU application. Such pushing of the configurations may be further facilitated via the API of the BU application. Specifically, the management application may push the configurations from the configuration datasource, through the API, and to the BU application.

In addition to provisioning configurations to the BU application after a query has been performed, embodiments provide for the management application to automatically provision new configurations to the BU application whenever configuration updates have been made. For instance, the managed configurations may be periodically updated (e.g., via new versions) within the configuration datasource (e.g., new or updated managed configurations may be made directly to the configuration datasource). As such, once an update to the managed configurations has been made, embodiments may provide for the managed application to automatically provision such updated configurations to the BU application via the API of the BU application. In some further embodiments, such automatic provisioning of updated configurations may be combined with the query functionality discussed above, such that only those portions of the updated configurations missing from the BU application will be provisioned to the BU application.

Furthermore, the managed application may be configured to remove configurations from the BU application. For example, if based on the query, it is determined that the BU application includes one or more additional, extraneous, outdated, or otherwise unmanaged configurations than is included in the managed configurations of the configuration datasource, the managed application may facilitate the removal, e.g., deletion, of such unmanaged configuration from the BU application. In particular, the management application may remove the unmanaged configurations from the BU application for deletion. Such removal of the configurations may be facilitated via the API of the BU application. Specifically, the management application may remove the configurations from BU application through the API.

Furthermore still, the managed application may be configured to download configurations from the BU application, such that the downloaded configurations can be copied to the configuration datasource. For example, if based on the query, it is determined that the BU application includes one or more new or updated configurations, which are not included in the managed configurations of the configuration datasource (such that the new or updated configurations are considered unmanaged configurations), the managed application may facilitate the downloading of such new or updated configurations from the BU application for storage within the configuration datasource. Such downloading of the new or updated configurations may be facilitated via the API of the BU application. Such embodiments may be used when the BU application has the most current and up-to-date configurations, and such up-to-date configurations are required to be provided to the configuration datasource so that the configuration datasource also has the most current and up-to-date configurations for further reference and/or analysis (e.g., as part of a version control system). In such embodiments, the new or updated configurations may remain on the BU application for use by the BU application (i.e., such new or updated are not removed from the BU application). Thus, it should be understood that the configuration data source can be updated with the most current managed configurations by either (a) manually creating updated configurations within the configuration data source, or (b) downloading updated configurations from the BU application.

### Exemplary System

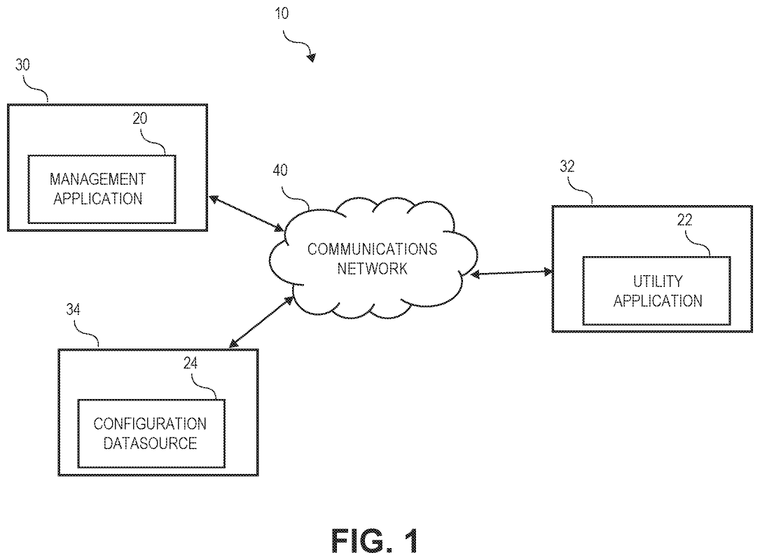

FIG. 1 depicts an exemplary environment for managing configurations of computer applications according to embodiments of the present invention. The environment may include a configuration management system 10, which includes management application 20, utility application 22 (also referred to as “BU application 22”), and configuration datasource 24 (with such components having been discussed in the previous paragraphs). The configuration management system 10 may further include one or more computing devices 30, which in some embodiments may store and execute the management application 20. The configuration management system 10 may further include one or more server devices 32, which in some embodiments may store and execute the BU application 22. The configuration management system 10 may further include one or more server devices 34, which in some embodiments may store and provide access to the configuration datasource 24. Each of the computing devices 30 and server devices 32, 34 may be in communication via a communications network 40.

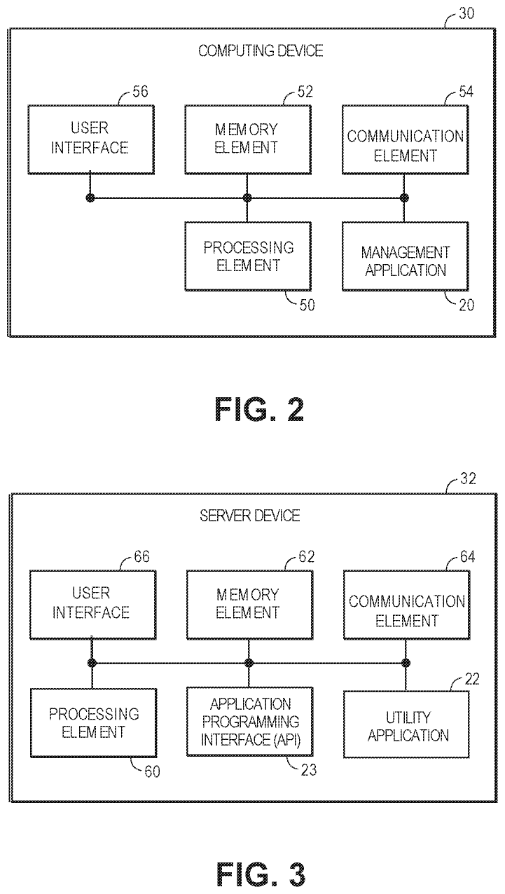

The computing device 30 may generally comprise any type of conventional or non-conventional computer, such as one or more tablet computers, laptop computers, desktop computers, workstation computers, smart phones, and the like. With reference to FIG. 2, the computing device 30 may include one or more processing elements 50 and one or more memory elements 52. The computing device 30 may also include circuitry capable of wired and/or wireless communication with the communications network 40, including, for example, communication element 54. Further, the computing device 30 may include a user interface 56 that permits a user to interact with the computing device 30 and/or any software programs associated with the computing device 30. Further, the computing device 30 may include one or more software applications configured with instructions for performing and/or enabling performance of at least some of the operations and steps set forth herein. In some embodiments, the software applications comprise programs stored on computer-readable media of the memory elements 52. For example, the software applications may include the management application 20, which is configured to manage the configurations of the BU application 22, as will be described in more detail below. In addition, the software applications may include an application programming interface (API) 23, which is associated with the BU application 22. In some embodiments, the API 23 may be integrated as part of the BU application 22.

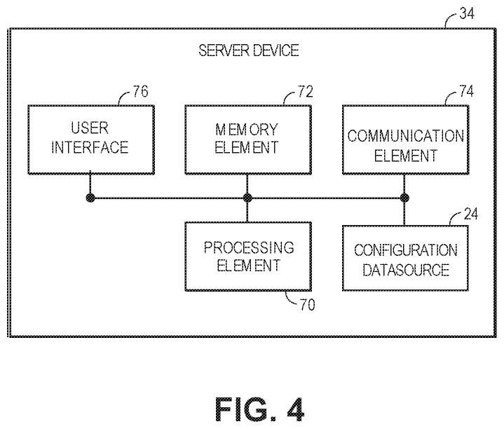

With reference to FIGS. 3 and 4, the server devices 32, 34 may generally comprise any type of computing device configured to retain electronic data and respond to requests to retrieve data as well as to store data. The server devices 32, 34 may comprise domain controllers, application servers, database servers, file servers, mail servers, catalog servers or the like, or combinations thereof. The server devices 32, 34 may additionally include a plurality of proxy servers, web servers, communications servers, routers, load balancers, and/or firewall servers, as are commonly known. Generally, the server devices 32, 34 may respectively include one or more processing elements 60, 70, one or more memory elements 62, 72, communication elements 64, 74, user interfaces 66, 76, and one or more software programs and/or datasources. For example, server device 32 may include the BU application 22 stored on computer-readable media of the memory elements 62. As was discussed previously, the BU application 22 may comprise a business utility application that provides business services. In some embodiments, the server device 32 will also include the API 23 that is hosted by or stored on computer-readable media of the memory elements 62, such as in association with and/or integrated as part of the BU application 22. The API 23 may be in the form of a computer program/application, a set of routines/protocols, and/or other software tools for facilitating communication and data transfer to/from the BU application 22. The API 23 may be accessed using software such as the management application 20, a software tool that makes calls to the API 23, an application that provides integration with the API 23 as middleware, and/or otherwise through execution of one or more script(s).

The server device 34 may include the configuration datasource 24 stored thereon (e.g., stored on or made available via the computer-readable media of the memory elements 72). In some embodiments, the configuration datasource 24 may comprise a database that stores the managed configurations and any other related information necessary for implementation of embodiments of the present invention. For example, the configuration datasource 24 may store and associate relevant data with the managed configurations, such as version numbers, creation timestamps, author/creator identifiers, comments, or the like. The configuration datasource 24 may utilize a variety of formats and structures within the scope of the invention. For instance, a text-based data structure, relational databases, and/or object-oriented databases may embody the configuration datasource 24.

The communications network 40 generally allows communication between the computing device 30 and server devices 32, 34. The communications network 40 may include the Internet, cellular communication networks, local area networks, metro area networks, wide area networks, cloud networks, plain old telephone service (POTS) networks, and the like, or combinations thereof. The communications network 40 may be wired, wireless, or combinations thereof and may include components such as modems, gateways, switches, routers, hubs, access points, repeaters, towers, and the like. The computing device 30, server devices 32, 34, and/or the API 23 may, for example, connect to the communications network 40 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 54, 64, 74 generally allow communication between the computing device 30 and the server devices 32, 34 via the communication network 40. The communication elements 54, 64, 74 may include signal or data transmitting and receiving circuits, such as antennas, amplifiers, filters, mixers, oscillators, digital signal processors (DSPs), and the like. The communication elements 54, 64, 74 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 54, 64, 74 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 54, 64, 74 may establish communication through connectors or couplers that receive metal conductor wires or cables, like Cat 6 or coax cable, which are compatible with networking technologies such as ethernet. In certain embodiments, the communication elements 54, 64, 74 may also couple with optical fiber cables. The communication elements 54, 64, 74 may respectively be in communication with the processing elements 50, 60, 70 and/or the memory elements 52, 62, 72.

The processing elements 50, 60, 70 may include electronic hardware components such as processors. The processing elements 50, 60, 70 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 50, 60, 70 may generally execute, process, or run instructions, code, code segments, software, firmware, programs, applications, apps, processes, services, daemons, or the like. For instance, the processing elements 50, 60, 70 may respectively execute or make available the management application 20, the BU application 22 and/or API 23, and the configuration datasource 24. The processing elements 50, 60, 70 may also include hardware components such as finite-state machines, sequential and combinational logic, and other electronic circuits that can perform the functions necessary for the operation of the current invention. The processing elements 50, 60, 70 may be in communication with the other electronic components through serial or parallel links that include universal busses, address busses, data busses, control lines, and the like.

The memory elements 52, 62, 72 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, memory elements 52, 62, 72 may be embedded in, or packaged in the same package as, the processing elements 50, 60, 70. The memory elements 52, 62, 72 may include, or may constitute, a “computer-readable medium.” The memory elements 52, 62, 72 may store the instructions, code, code segments, software, firmware, programs, applications, apps, services, daemons, or the like that are executed by the processing elements 50, 60, 70. In an embodiment, the memory elements 52, 62, 72 may respectively store and/or make available the management application 20, the BU application 22 and/or API 23, and the configuration datasource 24. As such, the configuration datasource 24 may be implemented via the memory elements 72 of the server 34 for purposes of storing and making available the managed configurations.

Finally, the user interfaces 56, 66, 76 may include various components that enable one or more users to share information and commands with the computing device 30 and/or server devices 32, 34. The user interfaces 56, 66, 76 may comprise one or more functionable inputs such as buttons, keyboard, switches, scrolls wheels, voice recognition elements such as a microphone, pointing devices such as mice, touchpads, tracking balls, styluses. The user interfaces 56, 66, 76 may additionally include an electronic display, such as a cathode ray tube, liquid crystal display, plasma, or touch screen that is operable to display visual graphics, images, text, etc. In certain embodiments, the user interfaces 56, 66, 76 may be configurable to present a graphical user interface (GUI) that is displayed via the electronic display. The GUI enables the user to interact with the electronic display by touching or pointing at display areas to provide information to the user interfaces 56, 66, 76.

As noted above, the configuration management system 10 includes the computing device 30, which includes the management application 20 configured to perform one or more of the steps outlined herein. In addition, the server device 32 includes the BU application 22 and/or the API 23, while the server device 34 may include the configuration datasource 24. Nevertheless, it should be understood that the management application 20, the BU application 22 and/or API 23, and the configuration datasource 24 may be included with and/or associated with more, fewer, or different computing elements. For example, each of the management application 20, the BU application 22 and/or API 23, and the configuration datasource 24 may be included and/or associated with a single computing device or server device. Alternatively, the management application 20, the BU application 22 and/or API 23, and the configuration datasource 24 may be distrusted among multiple computing devices and/or server devices (e.g., among multiple networked devices or in the cloud).

Through hardware, software, firmware, or various combinations thereof, the processing elements 50, 60, 70 may—alone or in combination with other processing elements—be configured to perform the operations of embodiments of the present invention (e.g., via execution of the management application 20). Specific embodiments of the technology will now be further described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled.

### Exemplary Computer-Implemented Method for Managing Configurations of Computer Applications

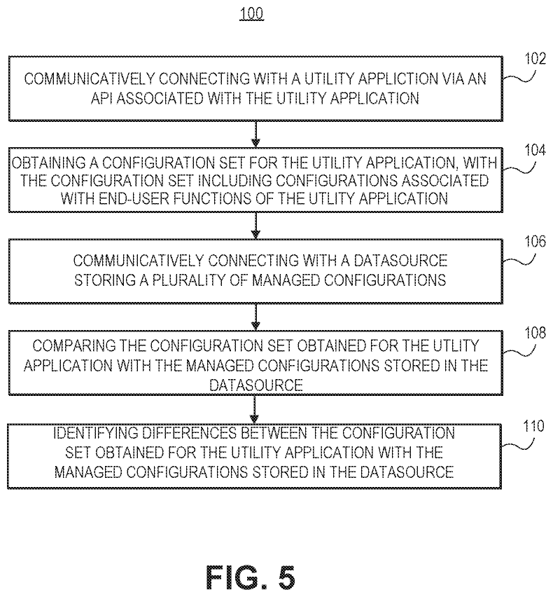

FIG. 5 depicts a flowchart including a listing of steps of an exemplary computer-implemented method 100 for managing configurations or configuration sets for computer applications. The steps are preferably performed in the order shown in FIG. 5. However, according to certain aspects of the present invention, the steps may alternatively be performed in a different order. Furthermore, some steps may be performed concurrently as opposed to sequentially. In addition, some steps may be optional.

The computer-implemented method 100 is described below, for ease of reference, as being executed by exemplary devices and components introduced with the embodiments illustrated in FIGS. 1-4. For example, the steps of the computer-implemented method 100 may be performed by the computing device 30, the server devices 32, 34, and/or the communications network 40 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 102, a connection can be made with a utility application via an application programming interface (API) associated with the utility application. In some embodiments, the connection is between the management application 20 and the BU application 22, as previously described. The management application 20 may be located on the computing device 30, while the BU application 22 may be located on the server device 32. In addition, such communication may be facilitated through the communications network 40 and the API 23, with the API 23 being associated with the BU application 22, and which may also be located on the server device 32.

Referring to step 104, a configuration set for the utility application may be obtained. Such a configuration set may be obtained from the utility application and/or from the server device 32 on which the utility application is located. The configuration set may include one or more (or all) configurations associated with end-user application functions of the utility application. In some embodiments, the utility application (i.e., the BU application 22) will be a computer program used for business services, application monitoring/managing, data analytics, and the like. The end-user application functions may include, as was previously described, user alerts, dashboard arrangement, scheduled reports, tags, calculatable fields, lookup functions, and the like. Thus, the configurations may comprise source code or other high-level instructions used by the BU application 22 for regulating or controlling the end-user application functions of the BU application 22. In some embodiments, the management application 20 may, after connecting with the BU application 22, perform a search or discovery of the BU application 22 to determine which configurations are currently being used by BU application 22. In some additional embodiments, the configurations may be copied or downloaded from the BU application 22 by the management application 20 and stored, at least temporarily, on the memory elements 52 of the computing device 30 for further analysis by the management application 20. Alternatively, the management application 20 may simply obtain access to the configurations while they are maintained on the BU application 22.

Referring to step 106, a connection can be made with a datasource storing a plurality of managed configurations. The datasource may be the configuration datasource 24 made available via the server 34. As such, the management application 20 (as provided by the computing device 30) can connect with the datasource 24 over the communications network 40, to access the managed configurations. In some embodiments, the managed configurations may be copied or downloaded from the configuration datasource 24 by the management application 20 and stored, at least temporarily, on the memory elements 52 of the computing device 30 for further analysis by the management application 20. Alternatively, the management application 20 may simply access to the managed configurations while they are maintained on the configuration datasource 24.

Referring to step 108, the configuration set obtained for the utility application may be compared with the managed configurations stored in the datasource. That is, the management application 20 may be configured to compare the currently-implemented configurations included in the configuration set obtained from the BU application 22 with the managed configurations stored in the datasource 24 to determine if any differences exist. Such differences may be extraneous unwanted configurations associated with the BU application 22, and which are not included within the current version of the managed configurations. Alternatively, such differences may be configurations not associated with the BU application 22, but which are included within the current version of the managed configurations.

Finally, referring to step 110, differences between the configuration set obtained for the utility application and the managed configurations stored in the datasource may be identified. In some embodiments, based on such identified differences, a difference report may be created. For example, the management application 20 may perform such comparison and generate a difference report indicative of the differences determined between the configuration set obtained for the utility application 22 and the managed configurations stored in the datasource 24. In some embodiments, the management application 20 may provide such a difference report to a user of the management application 20, such as via presentation on the electronic display of the user interface 56 of the computing device 30. In further embodiments, the difference report may be stored on memory elements 52 of the computing device 30 (e.g., written to log files) of the management application 20 for further reference and analysis.

In some embodiments, the configuration set obtained from the utility application will be a first configuration set. In addition, embodiments may provide for a second configuration set for the utility application to be obtained via the API associated with the utility application. Furthermore, the second configuration set may be compared with the managed configurations stored in the database. As such, embodiments provide for multiple configuration sets of the BU application 22 to be queried to determine differences between such configuration sets and the managed configurations stored in the datasource 24. As was discussed previously, in some embodiments, the BU application 22 may provide for multiple instances of execution, which may each be associated with an individual end-user's use of the BU application 22. Each instance may be associated with a particular configuration set, which regulates and/or controls the end-user application functions associated with the associated instance of the BU application 22 for the particular end-user. In addition, the instances may be associated with production and non-production occurrences of the BU application 22. As such, the particular configuration set associated with each instance may be different or unique. However, in some additional embodiments, the configuration sets associated with each instance may be the same.

In some additional embodiments, after comparing the configuration set obtained from the utility application with the managed configurations stored in the datasource, one or more updated configurations may be obtained from the configuration datasource for provisioning to the utility application. Such updated configurations may be provided to the utility application via the API of the utility application. For example, in some embodiments, it may be determined, based on the comparison between the configuration set obtained from the BU application 22 and the managed configurations stored in the configuration datasource 24, that the BU application 22 is missing one or more configurations and/or includes one or more outdated or otherwise unmanaged configurations. In such case, the management application 20 may obtain one or more updated configurations (e.g., from the datasource 24) and provision such updated configurations to the BU application 22 via the API 23. In some additional embodiments, the updated configurations may be obtained by the management application 20 from the datasource 24 for provisioning to the BU application 22.

The above paragraph provides a description of updated configurations being provided to the BU application 22 based on the comparison between the configuration set obtained from the utility application 22 and the managed configurations stored in the database 24. In additional embodiments, updated configurations may be provided to the BU application 22 automatically. For instance, new or updated versions of configurations and/or configuration sets may be provided to the BU application upon the creation and/or validation of the new versions of configurations and/or configuration sets. Once a new version of a configuration has been generated on the configuration datasource 24 (such that the new version is stored on the configuration datasource 24), the new version may be automatically provisioned (e.g., by the management application 20) to the BU application 22 for implementation. Such embodiments may be particularly beneficial, for instance, when synchronization of configurations is necessary among multiple instances of the BU application 22. For example, if multiple end-users require the same configurations to be used for their respective instance of the BU application 22, embodiments can be configured to automatically provision a common set of configurations to the BU application 22, such that the configurations used by the BU application 22 for such end-user instances are up-to-date and synchronized. Such automatic provisioning of updated configurations to the BU application 22 helps ensure that the configurations are consistently and accurately provided to the BU application 22.

Such embodiments may be also beneficial when developing new or updated configurations. For instance, a configuration in development may be initially developed and stored on the configuration datasource 24. From the configuration datasource 24, the configuration in development may be sent to the BU application 22 for testing (e.g., function or acceptance testing) by an instance of the BU application 22 used by a particular end-user. Any necessary corrections or changes to the configuration in development may be made to the configuration, as it is stored on the configuration datasource 24. Once the configuration has been tested and approved, embodiments may provide for the new or updated configuration to be automatically provisioned to the BU application 22 for use by any or all end-user instances, as required.

Embodiments provide for each version of the managed configurations and/or configuration sets to be stored in the configuration datasource 24 based on a version control system. For example, the managed configurations may be associated with metadata, such as a version number, a creation timestamp, an author/creator identifier, textual comments, or the like. As such, the managed configurations can be analyzed, as necessary, to determine when changes have been made to the managed configurations, who was responsible for making such changes, and why such changes were made. Such storage of each of the versions of the managed configurations can also be beneficial if it becomes necessary to obtain and use a back-up version of the managed configurations. For example, if a newly-created version of the managed configurations is shown to cause problems when an end-user is executing the BU application 22, embodiments may provide for a previously-used version of the managed configurations to be obtained (e.g., by the management application 20) from the configuration datasource 24 and provisioned to the BU application 22 via the API 23.

In addition to provisioning updated configurations, embodiments provide for unwanted configurations to be removed, e.g., deleted, from the BU application 22. For example, if after the comparison between the configuration set obtained for the utility application and the managed configurations stored in the datasource, it is determined that the utility application includes one or more unmanaged configurations that are no longer applicable for use by the utility application (e.g., the unmanaged configurations are out-of-date or otherwise unwanted), embodiments may provide for such unmanaged configurations to be removed and/or deleted from the utility application. Specifically, the management application 20 may connect with the BU application 22, via the API 23, and remove/delete the unmanaged configurations from the BU application 22. Such unmanaged configurations may, in some embodiments, be stored (e.g., in the datasource 24) for further analysis, or may be permanently deleted.

Furthermore, in some embodiments, one or more summary reports may be created for summarizing the above-described steps. Such summary report may be stored in association with the configuration data source 24 and/or the management application 20.

The method 100 discussed above may include additional, less, or alternate steps and/or device(s), including those discussed elsewhere herein.

### Additional Exemplary Computer-Implemented Method for Managing Configurations of Computer Applications

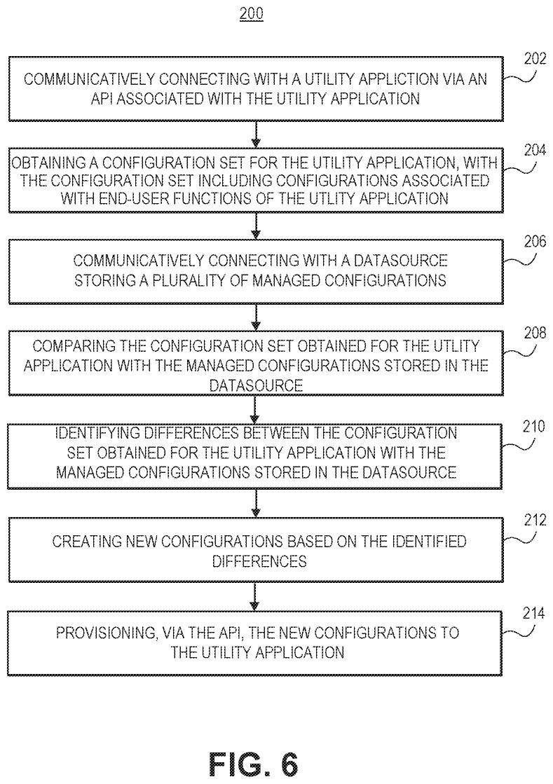

FIG. 6 depicts a flowchart including a listing of steps of another exemplary computer-implemented method 200 for managing configurations or configuration sets for computer applications. The steps are preferably performed in the order shown in FIG. 6. However, according to certain aspects of the present invention, the steps may alternatively be performed in a different order. Furthermore, some steps may be performed concurrently as opposed to sequentially. In addition, some steps may be optional.

The computer-implemented method 200 is described below, for ease of reference, as being executed by exemplary devices and components introduced with the embodiments illustrated in FIGS. 1-4. For example, the steps of the computer-implemented method 200 may be performed by the computing device 30, the server devices 32, 34, and/or the communications network 40 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 202, a connection can be made with a utility application via an application programming interface (API) associated with the utility application. In some embodiments, the connection is between the management application 20 and the BU application 22, as previously described. The management application 20 may be located on the computing device 30, while the BU application 22 may be located on the server device 32. In addition, such communication may be facilitated through the communications network 40 and the API 23, with the API 23 being associated with the BU application 22, and which may also be located on the server device 32.

Referring to step 204, a configuration set for the utility application may be obtained. Such a configuration set may be obtained from the utility application and/or from the server device 32 on which the utility application is located. The configuration set may include one or more (or all) configurations associated with end-user application functions for the utility application. In some embodiments, the utility application (i.e., the BU application 22) will be a computer program used for business services, application monitoring/managing, data analytics, and the like. The end-user application functions may include, as was previously described, user alerts, dashboard arrangement, scheduled reports, tags, calculatable fields, lookup functions, and the like. Thus, the configurations may comprise source code or other high-level instructions used by the BU application 22 for regulating or controlling the end-user application functions of the BU application 22. In some embodiments, the management application 20 may, after connecting with the BU application 22, perform a search or discovery of the BU application 22 to determine which configurations are currently being used by BU application 22. In some additional embodiments, the configurations may be copied or downloaded from the BU application 22 by the management application 20 and stored, at least temporarily, on the memory elements 52 of the computing device 30 for further analysis by the management application 20. Alternatively, the management application 20 may simply access to the configurations while they are maintained on the BU application 22.

Referring to step 206, a connection can be made with a datasource storing a plurality of managed configurations. The datasource may be the configuration datasource 24 made available via the server 34. As such, the management application 20 (as provided by the computing device 30) can connect with the datasource 24 over the communications network 40, to access the managed configurations. In some embodiments, the managed configurations may be copied or downloaded from the configuration datasource 24 by the management application 20 and stored, at least temporarily, on the memory elements 52 of the computing device 30 for further analysis by the management application 20. Alternatively, the management application 20 may simply access to the managed configurations while they are maintained on the configuration datasource 24.

Referring to step 208, the configuration set obtained for and/or from the utility application may be compared with the managed configurations stored in the datasource. That is, the management application 20 may be configured to compare the currently-implemented configurations included in the configuration set obtained from the BU application 22 with the managed configurations stored in the configuration datasource 24 to determine if any differences exist. Such differences may be outdated or otherwise unmanaged configurations associated with the BU application 22 and which are not included within the current version of the managed configurations on the configuration datasource 24.

Turning to step 210, differences between the configuration set obtained for the utility application and the managed configurations stored in the datasource may be identified. For example, as noted above, such identified differences may be outdated or otherwise unmanaged configurations associated with the BU application 22, which are not included within the current version of the managed configurations on the configuration datasource 24. In some embodiments, the management application 20 may be used to identify the differences between the configuration set obtained for the utility application 22 and the managed configurations stored in the datasource 24.

In step 212, new and/or updated configurations may be created based on the differences identified in step 210. In particular, the management application 20 may generate new and/or updated configurations using the managed configurations from the configuration datasource 24. However, in some embodiments, such new and/or updated configurations may include only those portions of the managed configurations from the configuration datasource 24 that were identified by the management application 20 as not being included with the unmanaged configurations of the BU application 22.

Furthermore, in step 214, the new and/or updated configurations may be provisioned to the utility application. In particular, upon creating the new and/or updated configurations, the management application 20 may communicatively connect with the BU application 22, via the API 23, and provision the new and/or updated configurations to the BU application 22, such that the BU application can implement the new and/or updated configurations. In some additional embodiments, the outdated and/or otherwise unmanaged configurations may be removed and/or deleted from the BU application 22. Furthermore, in some embodiments, one or more summary reports may be created for summarizing the above-described steps. Such summary report may be stored in association with the configuration data source 24 and/or the management application 20.

The method 200 discussed above may include additional, less, or alternate steps and/or device(s), including those discussed elsewhere herein.

### Further Exemplary Computer-Implemented Method for Managing Configurations of Computer Applications

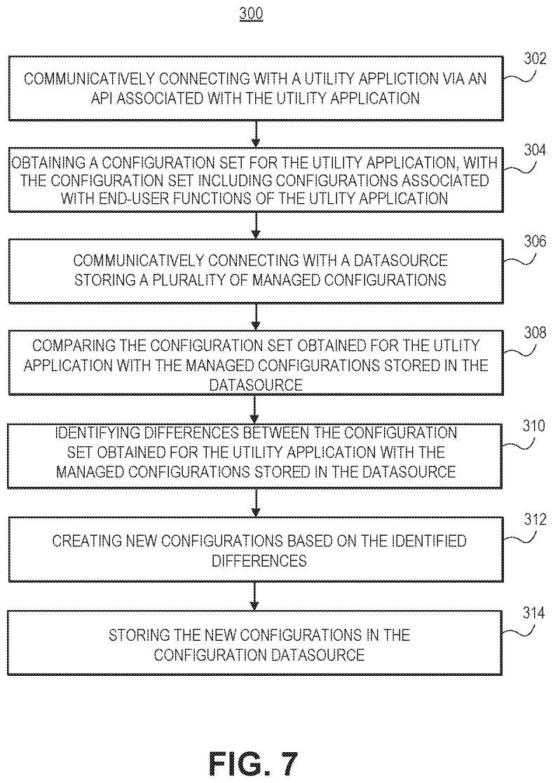

FIG. 7 depicts a flowchart including a listing of steps of another exemplary computer-implemented method 300 for managing configurations or configuration sets for computer applications. The steps are preferably performed in the order shown in FIG. 7. However, according to certain aspects of the present invention, the steps may alternatively be performed in a different order. Furthermore, some steps may be performed concurrently as opposed to sequentially. In addition, some steps may be optional.

The computer-implemented method 700 is described below, for ease of reference, as being executed by exemplary devices and components introduced with the embodiments illustrated in FIGS. 1-4. For example, the steps of the computer-implemented method 300 may be performed by the computing device 30, the server devices 32, 34, and/or the communications network 40 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 302, a connection can be made with a utility application via an application programming interface (API) associated with the utility application. In some embodiments, the connection is between the management application 20 and the BU application 22, as previously described. The management application 20 may be located on the computing device 30, while the BU application 22 may be located on the server device 32. In addition, such communication may be facilitated through the communications network 40 and the API 23, with the API 23 being associated with the BU application 22, and which may also be located on the server device 32.

Referring to step 304, a configuration set for the utility application may be obtained. Such a configuration set may be obtained from the utility application and/or from the server device 32 on which the utility application is located. The configuration set may include one or more (or all) configurations associated with end-user application functions for the utility application. In some embodiments, the utility application (i.e., the BU application 22) will be a computer program used for business services, application monitoring/managing, data analytics, and the like. The end-user application functions may include, as was previously described, user alerts, dashboard arrangement, scheduled reports, tags, calculatable fields, lookup functions, and the like. Thus, the configurations may comprise source code or other high-level instructions used by the BU application 22 for regulating or controlling the end-user application functions of the BU application 22. In some embodiments, the management application 20 may, after connecting with the BU application 22, perform a search or discovery of the BU application 22 to determine which configurations are currently being used by BU application 22. In some additional embodiments, the configurations may be copied or downloaded from the BU application 22 by the management application 20 and stored, at least temporarily, on the memory elements 52 of the computing device 30 for further analysis by the management application 20. Alternatively, the management application 20 may simply access to the configurations while they are maintained on the BU application 22.

Referring to step 306, a connection can be made with a datasource storing a plurality of managed configurations. The datasource may be the configuration datasource 24 made available via the server 34. As such, the management application 20 (as provided by the computing device 30) can connect with the datasource 24 over the communications network 40, to access the managed configurations. In some embodiments, the managed configurations may be copied or downloaded from the configuration datasource 24 by the management application 20 and stored, at least temporarily, on the memory elements 52 of the computing device 30 for further analysis by the management application 20. Alternatively, the management application 20 may simply access to the managed configurations while they are maintained on the configuration datasource 24.

Referring to step 308, the configuration set obtained for and/or from the utility application may be compared with the managed configurations stored in the datasource. That is, the management application 20 may be configured to compare the currently-implemented configurations included in the configuration set obtained from the BU application 22 with the managed configurations stored in the configuration datasource 24 to determine if any differences exist. Such differences may be new, updated, or otherwise unmanaged configurations associated with the BU application 22 and which are not included within the current version of the managed configurations on the configuration datasource 24.

Turning to step 310, differences between the configuration set obtained for the utility application and the managed configurations stored in the datasource may be identified. For example, as noted above, such identified differences may be new, updated, or otherwise unmanaged configurations associated with the BU application 22, which are not included within the current version of the managed configurations on the configuration datasource 24. In some embodiments, the management application 20 may be used to identify the differences between the configuration set obtained for the utility application 22 and the managed configurations stored in the datasource 24.

In step 312, new and/or updated configurations may be created based on the differences identified in step 310. In particular, the management application 20 may generate new and/or updated configurations using the unmanaged configurations from the BU application 22. However, in some embodiments, such new and/or updated configurations may include only those portions of the unmanaged configurations from the BU application 22 that were identified by the management application 20 as not being included with the managed configurations of the configuration datasource 24.

Furthermore, in step 314, the new and/or updated configurations may be provisioned to and/or stored within the datasource for further/future use. In particular, upon creating the new and/or updated configurations, the management application 20 may communicatively connect with the configuration datasource 24 and provision the new and/or updated configurations to the configuration datasource 24 (i.e., for storage in the configuration datasource 24), such that the managed configurations of the configuration datasource 24 will be updated to include the new and/or updated configurations. In some additional embodiments, the outdated configurations may be removed and/or deleted from the configuration datasource 24. Alternatively, the outdated configurations may remain stored on the configuration datasource 24 for further reference (e.g., as part of the version control system). Furthermore, in some embodiments, one or more summary reports may be created for summarizing the above-described steps. Such summary report may be stored in association with the configuration data source 24 and/or the management application 20.

The method 300 discussed above may include additional, less, or alternate steps and/or device(s), including those discussed elsewhere herein.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated unless so stated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. A computer-implemented method for managing configuration sets for computer applications via one or more transceivers and/or processors, said method comprising the steps of:
communicatively connecting with a utility application via an application programming interface (API) associated with the utility application;
obtaining, via the API, a configuration set for the utility application, wherein the configuration set includes one or more configurations associated with end-user functions of the utility application;
communicatively connecting with a datasource storing a plurality of managed configurations;
comparing the configuration set obtained for the utility application with the managed configurations stored in the datasource; and
identifying differences between the configuration set obtained for the utility application and the managed configurations stored in the datasource.

2. The computer-implemented method of claim 1, wherein the configuration set is a first configuration set, further comprising the steps of:
obtaining, via the API, a second configuration set for the utility application; and
comparing the second configuration set obtained for the utility application with the managed configurations stored in the datasource.

3. The computer-implemented method of claim 1, further comprising the steps of:
creating one or more updated configurations based on the comparison between the configuration set obtained for the utility application and the managed configurations stored in the datasource; and
provisioning, via the API, the updated configurations to the utility application.

4. The computer-implemented method of claim 3, wherein the configuration set for the utility application is an original configuration set, further comprising the step of:
removing, via the API, the original configuration set from the utility application.

5. The computer-implemented method of claim 1, further comprising the steps of:
determining, based on the comparison between the configuration set obtained for the utility application and the managed configurations stored in the datasource, one or more unmanaged configurations included in the configuration set obtained for the utility application; and
downloading, via the API, the unmanaged configurations from the utility application.

6. The computer-implemented method of claim 5, the steps of:
creating one or more updated configurations based on the unmanaged configurations downloaded from the utility application; and
storing the updated configurations in the configuration datasource, wherein the updated configurations form part of the managed configurations.

7. The computer-implemented method of claim 1, further comprising the step of:
creating a difference report indicative of the differences identified between the configuration set obtained for the utility application and the managed configurations stored in the datasource.

8. The computer-implemented method of claim 7, wherein the difference report is stored in association with the management application for further analysis.

9. The computer-implemented method of claim 1, wherein the utility application and the API are associated with a first server device, wherein the step of communicatively connecting with the utility application includes connecting with the first server device over a communications network.

10. The computer-implemented method of claim 9, wherein the datasource is associated with a second server device, wherein the step of communicatively connecting with the datasource includes connecting with the first server device over the communications network.

11. The computer-implemented method of claim 1, wherein the end-user functions comprise one or more of the following: user alerts, scheduled reports, and dashboard configurations.

12. A system for managing configuration sets for computer applications, the system comprising one or more processors individually or collectively programmed to:
communicatively connect with a utility application via an application programming interface (API) associated with the utility application;
obtain, via the API, a configuration set for the utility application, wherein the configuration set includes one or more configurations associated with end-user functions of the utility application;
communicatively connect with a datasource storing a plurality of managed configurations;
compare the configuration set obtained for the utility application with the managed configurations stored in the datasource; and
identify differences between the configuration set obtained for the utility application and the managed configurations stored in the datasource.

13. The system of claim 12, wherein the configuration set is a first configuration set, and wherein the one or more processors are further programmed to:
obtain, via the API, a second configuration set for the utility application; and
compare the second configuration set obtained for the utility application with the managed configurations stored in the datasource.

14. The system of claim 12, wherein the one or more processors are further programmed to:
create one or more updated configurations based on the comparison between the configuration set obtained for the utility application and the managed configurations stored in the datasource; and
provision, via the API, the updated configurations to the utility application.

15. The system of claim 14, wherein the configuration set for the utility application is an original configuration set, wherein the one or more processors are further programmed to remove, via the API, the original configuration set from the utility application.

16. The system of claim 12, wherein the one or more processors are further programmed to:
determine, based on the comparison between the configuration set obtained for the utility application and the managed configurations stored in the datasource, one or more unmanaged configurations included in the configuration set obtained for the utility application; and
download, via the API, the unmanaged configurations from the utility application.

17. The system of claim 16, the steps of:
creating one or more updated configurations based on the unmanaged configurations downloaded from the utility application; and
storing the updated configurations in the configuration datasource, wherein the updated configurations form part of the managed configurations.

18. The system of claim 12, further comprising the step of:
creating a difference report indicative of the differences identified between the configuration set obtained for the utility application and the managed configurations stored in the datasource.

19. The system of claim 18, wherein the one or more processors are programmed to store the difference report in association with the management application for further analysis.

20. The system of claim 12, wherein the utility application and the API are associated with a first server device, wherein the one or more processors are programmed to communicatively connect with the utility application by connecting with the first server device over a communications network.

21. The system of claim 20, wherein the datasource is associated with a second server device, wherein the one or more processors are programmed to communicatively connect with the datasource by connecting with the first server device over the communications network.

22. A non-transitory computer-readable storage media having computer-executable instructions for managing configuration sets for computer applications stored thereon, wherein when executed by at least one processor the computer-executable instructions cause the at least one processor to:
communicatively connect with a utility application via an application programming interface (API) associated with the utility application;
obtain, via the API, a configuration set for the utility application, wherein the configuration set includes one or more configurations associated with end-user functions of the utility application;
communicatively connect with a datasource storing a plurality of managed configurations;
compare the configuration set obtained for the utility application with the managed configurations stored in the datasource; and
report differences between the configuration set obtained for the utility application and the managed configurations stored in the datasource.

23. The non-transitory computer-readable media of claim 22, wherein the configuration set is a first configuration set, and wherein the computer-executable instructions further cause the at least one processor to:
obtain, via the API, a second configuration set for the utility application; and
compare the second configuration set obtained for the utility application with the managed configurations stored in the datasource.

24. The non-transitory computer-readable media of claim 22, wherein the computer-executable instructions further cause the at least one processor to:
create one or more updated configurations based on the comparison between the configuration set obtained for the utility application and the managed configurations stored in the datasource; and
provision, via the API, the updated configurations to the utility application.

25. The non-transitory computer-readable media of claim 24, wherein the configuration set for the utility application is an original configuration set, wherein the computer-executable instructions further cause the at least one processor to remove, via the API, the original configuration set from the utility application.

26. The non-transitory computer-readable media of claim 22, wherein the computer-executable instructions further cause the at least one processor to:
determine, based on the comparison between the configuration set obtained for the utility application and the managed configurations stored in the datasource, one or more unmanaged configurations included in the configuration set obtained for the utility application; and
download, via the API, the unmanaged configurations from the utility application.

27. The non-transitory computer-readable media of claim 26, wherein the computer-executable instructions further cause the at least one processor to:
create one or more updated configurations based on the unmanaged configurations downloaded from the utility application; and
store the updated configurations in the configuration datasource, wherein the updated configurations form part of the managed configurations.

28. The non-transitory computer-readable media of claim 22, wherein the computer-executable instructions further cause the at least one processor t:
create a difference report indicative of the differences identified between the configuration set obtained for the utility application and the managed configurations stored in the datasource.

29. The non-transitory computer-readable media of claim 28, wherein the computer-executable instructions further cause the at least one processor to store the difference report in association with the management application for further analysis.
